(19) United States
(12) Patent Application Publication
(10) Pub. No.: US 2010/0077457 A1
(43) Pub. Date: Mar. 25, 2010

(54) METHOD AND SYSTEM FOR SESSION MANAGEMENT IN AN AUTHENTICATION ENVIRONMENT

(75) Inventors: Emily H. Xu, Palo Alto, CA (US); Qingwen Cheng, Pleasanton, CA (US)

Correspondence Address: OSHA LIANG L.L.P./SUN, TWO HOUSTON CENTER, 909 FANNIN, SUITE 3500, HOUSTON, TX, 77010, US

(73) Assignee: SUN MICROSYSTEMS, INC., Santa Clara, CA (US)

(21) Appl. No.: 12/236,287

(22) Filed: Sep. 23, 2008

(51) Int. Cl. H04L 9/32

(52) U.S. Cl. 726/4

(57) ABSTRACT

A method for authentication. The method includes receiving a re-directed access request for a resource associated with a second authentication level, where a user has requested, the user is associated with a session, and the session associated with a first authentication level. The method further includes identifying a second authentication context using the second authentication level, generating an authentication request using the second authentication context, and sending the authentication request to an identity provider. In response the identity provider identifies an authentication scheme corresponding to the second authentication context, obtains authentication information from the user, authenticates the user using the authentication information, and generates an assertion, in response to successful authentication, using the second authentication level, and the authentication scheme. The method further includes receiving the assertion, associating the session with the second authentication level to generate an upgraded session to the user access to the resource.

### BACKGROUND

A variety of system resources may be located in a system. In some system environments, these system resources are secured and may only be accessed by authenticated users using a particular authentication scheme for each resource. One example of authentication includes using a single sign-on (SSO) method, which enables a user to authenticate once to create a session and gain access to multiple resources (each having the same authentication scheme) using the session without being prompted to log in again.

Users may be authenticated by passing authentication information among a series of modules in a system. Authentication information may be transferred between modules in the system using a variety of methods, such as Security Assertion Markup Language (SAML) version 2.0, which is an Extensible Markup Language (XML) based standard for exchanging authentication and authorization data between modules. For example, SAML may be used to communicate authorization information between an identity provider, a service provider, and a user. The identity provider may produce assertions regarding the user's authentication and the service provider may generally protect the resources, receive the assertions, and grant access based on the assertions.

In most environments using SAML, when a user is authenticated using one authentication context, requests to a resource protected by a different authentication context require the creation of a new session using the new authentication context.

### SUMMARY

In general, in one aspect, the invention relates to a computer readable storage medium comprising computer readable program code embodied therein for causing a computer system to receive, from a resource system, a re-directed access request for a resource associated with a second authentication level, wherein a user has requested access to the resource, wherein the user is associated with a session, and wherein the session associated with a first authentication level, identify a second authentication context using the second authentication level, generate an authentication request using the second authentication context, send the authentication request to an identity provider, wherein the identity provider: identifies an authentication scheme corresponding to the second authentication context, obtains authentication information from the user, authenticates the user using the authentication information, and generates an assertion, in response to successful authentication, using the second authentication level, and the authentication scheme, receive the assertion, associate the session with the second authentication level to generate an upgraded session, and allow the user access to the resource using the upgraded session.

In general, in one aspect, the invention relates to a service provider, configured to receive, from a resource system, a re-directed access request for a resource associated with a second authentication level, wherein a user has requested access to the resource, wherein the user is associated with a session, and wherein the session associated with a first authentication level, identify a second authentication context using the second authentication level, generate an authentication request using the second authentication context, send the authentication request to an identity provider, wherein the identity provider: identifies an authentication scheme corresponding to the second authentication context, obtains authentication information from the user, authenticates the user using the authentication information, and generates an assertion, in response to successful authentication, using the second authentication level, and the authentication scheme, receive the assertion, associate the session with the second authentication level to generate an upgraded session, and allow the user access to the resource using the upgraded session.

In general, in one aspect, the invention relates to a method for authentication. The method includes receiving, from a resource system, a re-directed access request for a resource associated with a second authentication level, wherein a user has requested access to the resource, wherein the user is associated with a session, and wherein the session associated with a first authentication level, identifying a second authentication context using the second authentication level, generating an authentication request using the second authentication context, sending the authentication request to an identity provider, wherein the identity provider: identifies an authentication scheme corresponding to the second authentication context, obtains authentication information from the user, authenticates the user using the authentication information, and generates an assertion, in response to successful authentication, using the second authentication level, and the authentication scheme, receiving the assertion, associating the session with the second authentication level to generate an upgraded session, and allowing the user access to the resource using the upgraded session.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flow chart in accordance with one or more embodiments of the invention

FIG. 3 shows a flow diagram in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system to manage a user session in an authentication environment. Specifically, embodiments of the invention allow a user who has been previously authenticated in a session using one authentication context to access a resource that is secured using another authentication context without creating a new session. In one or more embodiments of the invention, the user may access the resource when the new authentication context is of a lower or equal authentication level as compared to the original authentication context. In one or more embodiments of the invention, when the new authentication context is greater than the original authentication context, the authenticated user may reauthenticate for the new authentication context and access the resource using the same session after it has been upgraded with the new authentication context.

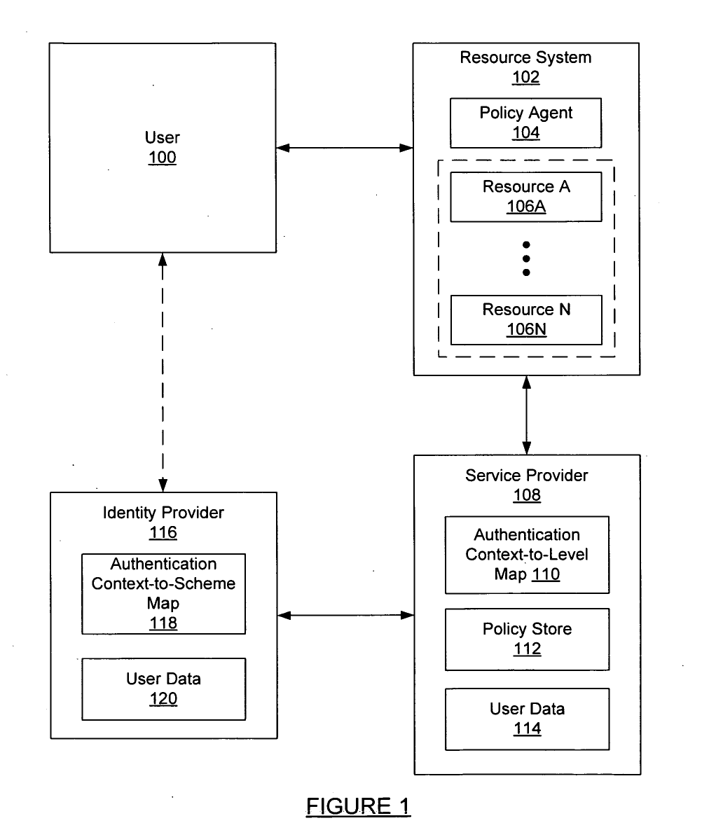

FIG. 1 shows a system in accordance with one or more embodiments of the invention. The system includes a user (100) interfacing with a resource system (102). The resource system (102) includes functionality to interface with a service provider (108), which in turn interfaces with an identity provider (116).

The resource system (102) includes a policy agent (104) and one or more resources (106A, 106N). In one or more embodiments of the invention, the policy agent (104) intercepts requests to access the resources (106A, 106N) and determines whether the user is authenticated and authorized to access the requested resource. When the user is authenticated to access a requested resource (106A, 106N), the policy agent (104) grants access. According to one or more embodiments of the invention, when the user is not authenticated to access a requested resource, the policy agent (104) passes the authentication request to the service provider (108).

According to one or more embodiments of the invention, the policy agent (104) may intercept a request to access a resource from the user (100). The user (100) may request access to a resource (106A, 106N) over a single sign-on environment. Accordingly, upon authentication for one resource, the user may be authenticated for a variety of other resources. In general, the resource system (102) receives a request for access to a resource and either allows access to that resource or sends the request for further authentication. According to one or more embodiments of the invention, the policy agent (104) may determine whether the user is allowed to access a requested resource. Each resource (106A, 106N) may be associated with an authentication level required to access the resource. According to one or more embodiments of the invention, the resources for which the user has access is limited depending on the authentication level the user is associated with at the time the user requests access to a resource.

In one or more embodiments of the invention, the service provider (108) includes an authentication context-to-level map (110), a policy store (112), and locally stored user data (114). In general, the service provider receives an authentication request that includes a particular authentication level and manages the user session. The service provider receives information regarding the necessary authentication level needed in the request received. The authentication context-to-level map (110) provides a mapping between a variety of authentication contexts and authentication levels. In one or more embodiments of the invention, an authentication level identifies the authentication strength of a particular authentication context. Various resources (106A-106N) may be accessible using a variety of authentication contexts. An authentication context is information that is required before a user may be authenticated. This information may include the method of authentication used. Some examples of authentication contexts include, but are not limited to, Password, Kerberos, Smartcard, Secure Remote Password, etc.

In one embodiment of the invention, the policy store (112) defines what authentication level is required to access a given resource. In one embodiment of the invention, the policy agent (104) may interact with the policy store (112) to determine what authentication level is required by the user to access a given resource. The service provider (108) also includes user data (114). According to one or more embodiments of the invention, user data (114) is associated with a user, such as user (100).

The identity provider (116) includes functionality to interface with the user (100), directly or indirectly, to authenticate the user using an identified authentication scheme. An authentication scheme is an authentication mechanism for authenticating a user and is associated with an authentication context. Some examples of authentication schemes include but are not limited to: Lightweight Directory Access Protocol (LDAP), Remote Authentication Dial In User Service (RADIUS), Kerberos, and Smart Card. In general, the identity provider (116) receives a request for an assertion for a particular authentication context and returns the assertion. The identity provider (116) may also include an authentication context-to-scheme map (118) and locally stored user data (120).

The authentication context-to-scheme map (118) includes a mapping between various authentication contexts and authentication schemes. The authentication context-to-scheme map (118) may also include a mapping between authentication contexts and authentication levels, where the authentication levels identify the strength of the authentication contexts. The locally stored user data (120) may include, for example, authentication context, authentication scheme, and/or authentication level associated with the user for the user's current session.

The identity provider (116) may also receive requests for authentication using an authentication context and, in response, identify the corresponding authentication scheme, and return an assertion. If the authentication context received is associated with a greater authentication level than the authentication context currently associated with the user in the locally stored user data, the identity provider (116) may interface with the user (100) to retrieve additional authentication information. According to one or more embodiments of the invention, the identity provider (116) identifies the corresponding authentication scheme using the authentication context-to-scheme map (118) and subsequently generates an assertion for the authentication context using the identified authentication scheme.

According to one or more embodiments of the invention, after the identity provider (116) generates an assertion, the assertion may be delivered to the service provider (108). The service provider (108) processes the assertion and upgrades the user session to the corresponding authentication level. The policy agent (104) grants access to the requested resource (106A, 106N).

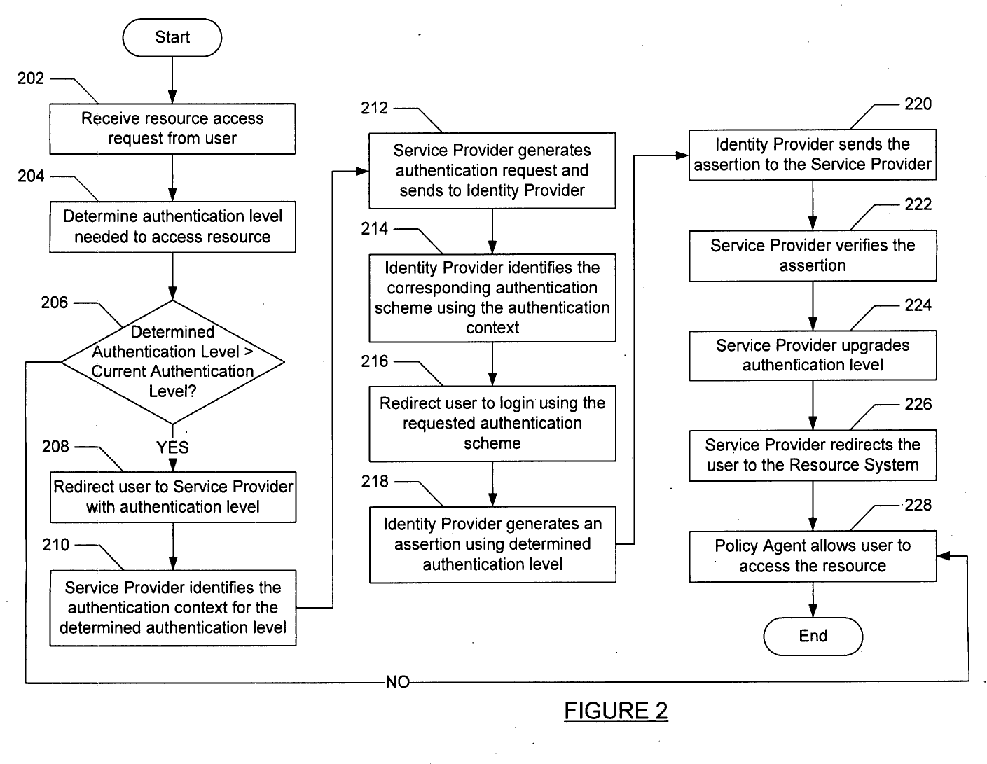

FIG. 2 shows a flowchart in accordance with one or more embodiments of the invention. More specifically, FIG. 2 details a method for allowing a user with a previously authenticated session to access a requested resource in accordance with one or more embodiments of the invention.

At 202, the resource system receives a request to access a resource from a user. At 204, the resource system obtains the authentication level needed to access the resource from the policy store.

At 206, a determination is made by the identity provider about whether the required authentication level to access the requested resource is greater than the authentication level at which the user is currently authenticated. When the required authentication level is not greater than the current authentication level, then the flowchart continues at 228, and the policy agent allows the user to access the resource.

In the alternative, if at 206 the required authentication level to access the requested resource is greater than the authentication level at which the user is currently authenticated, the flowchart continues at 208 and the user is redirected to the service provider. The required authentication level (determined in 204) is also provided to the service provider. At 210, the service provider, in response to the re-directed access request, identifies the authentication context associated with the requested resource for the required authentication level. According to one or more embodiments, the service provider identifies the matching authentication context using the authentication context-to-level map. At 212, the service provider generates an authentication request using the authentication context and sends the authentication request to the identity provider.

At 214, the identity provider identifies the authentication scheme that corresponds to the authentication context sent by the service provider. According to one or more embodiments of the invention, the identity provider identifies the authentication scheme using the authentication context-to-scheme map. The authentication scheme corresponds to an authentication level.

At 216, the user is redirected to login using the authentication scheme identified at 214. According to one or more embodiments of the invention, the user's current authentication level may be found in the user data stored in the identity provider. Further, as part of 216, the user may be prompted to enter authentication information.

At 218, the identity provider generates an assertion (See Example 2) using the context corresponding to the required authentication level and the authentication scheme. At 220, the identity provider returns the assertion to the service provider.

At 222, the service provider verifies the assertion. At 226, the service provider upgrades the user's authentication level using the assertion. At 228 the service provider redirects the user to the resource system. At 230, the policy agent allows the user to access the requested resource.

While the various steps in this flowchart are presented and described sequentially, one of ordinary skill will appreciate that some or all of the steps may be executed in different orders, may be combined or omitted, and some or all of the steps may be executed in parallel. In addition, steps such as store acknowledgements have been omitted to simplify the presentation.

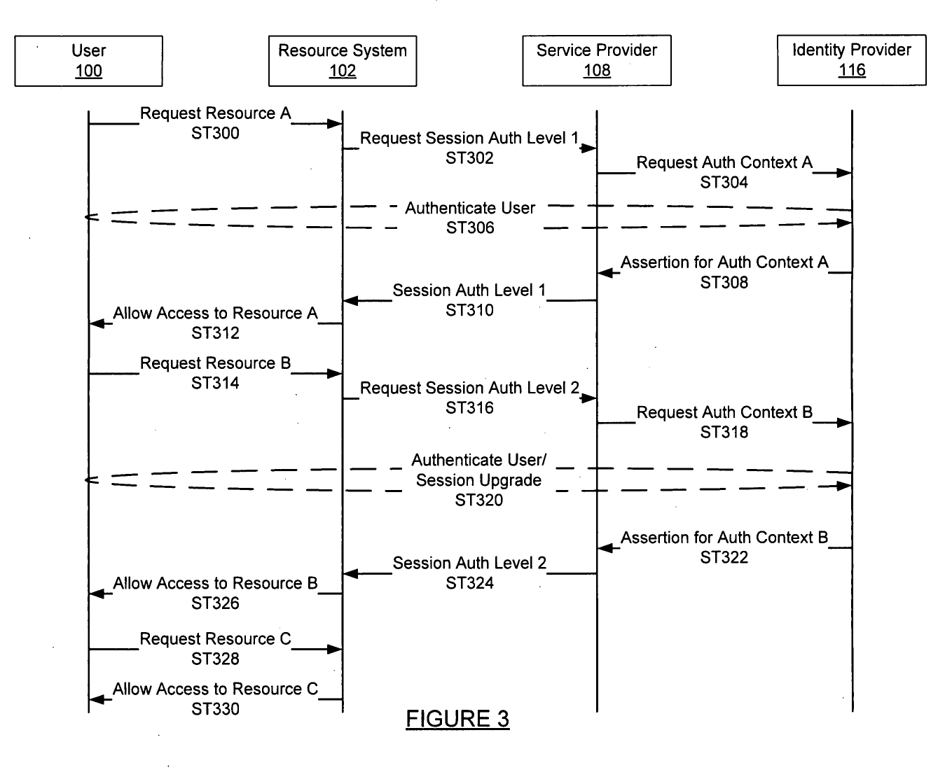

FIG. 3 shows an example flow diagram according to one or more embodiments of the invention. Specifically, FIG. 3 shows the flow of data between a user (100), a resource system (102), a service provider (108), and an identity provider (116) where the user (100) begins by requesting access a resource before a session for the user has been initiated. After a session has been initiated, the example shows the user requesting access to various other resources.

At ST 300, the user sends a request to access Resource A to the resource system (102). The resource system (102) determines (using a policy agent and a policy store) that the user needs Authentication Level 1 to access Resource A. At ST 302, the resource system (102) sends a request to the service provider to begin a session associated with the user with Authentication Level 1. The service provider (108) receives the request and identifies that Authentication Context A is associated with Authentication Level 1 using the authentication context-to-level map shown in Example 1. According to one or more embodiments of the invention, multiple authentication contexts may be associated with the same authentication level, as is shown by Authentication Context B and Authentication Context C both corresponding to authentication level 2.

### EXAMPLE 1

### Authentication Context-to-Level Map

urn:oasis:names:tc:SAML:2.0:ac:classes:AuthenticationContextA|1
urn:oasis:names:tc:SAML:2.0:ac:classes:AuthenticationContextB|2
urn:oasis:names:tc:SAML:2.0:ac:classes:AuthenticationContextC|2

The service provider (108) then sends an authentication request (See Example 2) that includes the Authentication Context A to the identity provider (116).

### EXAMPLE 2

### Authentication Request

<samlp:AuthnRequest xmlns:samlp=“urn:oasis:names:tc:SAML:2.0:protocol”
ID=“s28a8e330b61b884c42aacdcbee7faada46069b8ce” Version=“2.0”
IssueInstant=“2008-07-21T21:24:28Z”
Destination=“http://am-aix-
01.red.iplanet.com:9080/idp0721/SSORedirect/metaAlias/idp”
ForceAuthn=“false” IsPassive=“false”
ProtocolBinding=“urn:oasis:names:tc:SAML:2.0:bindings:HTTP-Artifact”
AssertionConsumerServiceURL=“http://neuhome.red.iplanet.com:8080/sp0721/Consumer/
metaAlias/sp”>
<saml:Issuer
xmlns:saml=“urn:oasis:names:tc:SAML:2.0:assertion”>http://neuhome.red.iplanet.com:8080/
sp0721</saml:Issuer>
<samlp:NameIDPolicy xmlns:samlp=“urn:oasis:names:tc:SAML:2.0:protocol”
Format=“urn:oasis:names:tc:SAML:2.0:nameid-format:persistent”
SPNameQualifier=“http://neuhome.red.iplanet.com:8080/sp0721”
AllowCreate=“true”></samlp:NameIDPolicy>
<samlp:RequestedAuthnContext
xmlns:samlp=“urn:oasis:names:tc:SAML:2.0:protocol”
Comparison=“exact”><saml:AuthnContextClassRef
xmlns:saml=“urn:oasis:names:tc:SAML:2.0:assertion”>urn:oasis:names:tc:SAML:2.0:ac:
classes:AuthenticationContextA</saml:AuthnContextClassRef></samlp:RequestedAuthnContext>
</samlp:AuthnRequest>

In this example shown, the user (100) has not yet begun a session. Accordingly, at ST 306, the identity provider (116) retrieves authentication information from the user. To authenticate the user, the identity provider (116) identifies the authentication scheme that corresponds to Authentication Context A. According to one or more embodiments of the invention, the identity provider (116) identifies the corresponding authentication scheme using the authentication context-to-scheme map (See Example 3).

### EXAMPLE 3

### Authentication Context-to-Scheme Map

urn:oasis:names:tc:SAML:2.0:ac:classes:AuthenticationContextA|module=
LDAP
urn:oasis:names:tc:SAML:2.0:ac:classes:AuthenticationContextB|module=
RADIUS
urn:oasis:names:tc:SAML:2.0:ac:classes:AuthenticationContextC|module=
Smart Card

According to one or more embodiments of the invention, the identity provider (116) prompts the user to enter authentication information using an authentication scheme matching Authentication Context A. As shown in Example 3, the matching Authentication Scheme is LDAP. Upon authenticating the user, the identity provider (116) generates an assertion (See Example 4) using the authentication context and sends the assertion to the service provider (108) at ST 308.

### EXAMPLE 4

### Assertion

<saml:Assertion Version=“2.0”
ID=“s23eab1afe8e1185fb8322f9cd622452342647ff0f”
IssueInstant=“2008-07-21T21:35:43Z”>
<saml:Issuer>http://am-aix-01.red.iplanet.com:9080/idp0721
</saml:Issuer><saml:Subject>
<saml:NameID
NameQualifier=“http://am-aix-01.red.iplanet.com:9080/idp0721”
SPNameQualifier=“http://neuhome.red.iplanet.com:8080/sp0721”
Format=“urn:oasis:names:tc:SAML:2.0:nameid-
format:persistent”>A9hKqSvsB/uZpVEHj8RSChirJdz6</saml:NameID>
<saml:SubjectConfirmation
Method=“urn:oasis:names:tc:SAML:2.0:cm:bearer”>
<saml:SubjectConfirmationData NotOnOrAfter=“2008-07-21T21:45:43Z”
InResponseTo=“s26640e5a2ea11db9bfe80537db06beec7098265ed”
Recipient=“http://neuhome.red.iplanet.com:8080/sp0721/Consumer/metaAlias/sp”>
</saml:SubjectConfirmationData></saml:SubjectConfirmation>
</saml:Subject><saml:Conditions NotBefore=“2008-07-21T21:25:43Z”
NotOnOrAfter=“2008-07-21T21:45:43Z”>
<saml:AudienceRestriction>
<saml:Audience>http://neuhome.red.iplanet.com:8080/sp0721</saml:Audience>
</saml:AudienceRestriction>
</saml:Conditions>
<saml:AuthnStatement AuthnInstant=“2008-07-21T21:35:28Z”
SessionIndex=“s2545adab83815b88c501e7743f4d1f814c1206701”><saml:AuthnContext>
<saml:AuthnContextClassRef>urn:oasis:names:tc:SAML:2.0:ac:classes:AuthenticationContextA
</saml:AuthnContextClassRef>
</saml:AuthnContext></saml:AuthnStatement></saml:Assertion>

The service provider (108) verifies the assertion and identifies the authentication level using the authentication context. Using Example 1, the service provider would identify that Authentication Context A is associated with Authentication Level 1. At ST 310, the service provider (108) then generates a session with Authentication Level 1. At ST 312, the resource system (102) allows the user access to Resource A.

The second phase of the example begins at ST 314, where the user (100) requests a second resource. In the example shown, the user (100) sends a request to the resource system (102) to access Resource B. The resource system (102) determines that access to Resource B requires Authentication Level 2. At ST 316, the resource system (102) then requests a session with Authentication Level 2 to the service provider (108).

When the service provider receives the request for the session, it forms an authentication request and at ST 318, the service provider (108) sends the authentication request to the identity provider (116). Referring to Example 1, in this authentication request, the metadata will now identify Authentication Context B as the required authentication context for the requested resource. The identity provider determines the authentication scheme associated with the authentication request and prompts the user to enter authentication information at ST 320. Referring to Example 3, RADIUS is the authentication scheme associated with Authentication Context B. Once the user is authenticated, the identity provider (116) can upgrade the session to Authentication Level 2.

The identity provider (116) may then create an assertion using the authentication and Authentication Context B. At ST 322, the identity provider (116) sends the assertion to the service provider (108). The service provider (116) receives and verifies the assertion. The service provider (108) determines that the new authentication level (Authentication Level 2) is greater than the current authentication level as is recorded in the service provider (Authentication Level 1). The service provider upgrades the authentication level to Authentication Level 2.

At ST 324, the resource system (102) receives notice that the session is now at Authentication Level 2. At ST 326, the resource system (102) allows the user (100) to access Resource B.

In a third phase of the example, the user, now in a session with authentication level 2, requests resource C at ST 328. In the example, Resource C is also located in the resource system (102). The resource system determines that Resource C requires Authentication Level 2. The resource system determines that the user (100) is already authenticated at Authentication Level 2. At ST 338, the resource system (102) allows the user (100) to access Resource C.

One or more embodiments of the invention allows for system resources to be accessed by a user by upgrading a user's session instead of initiating a new session for the user.

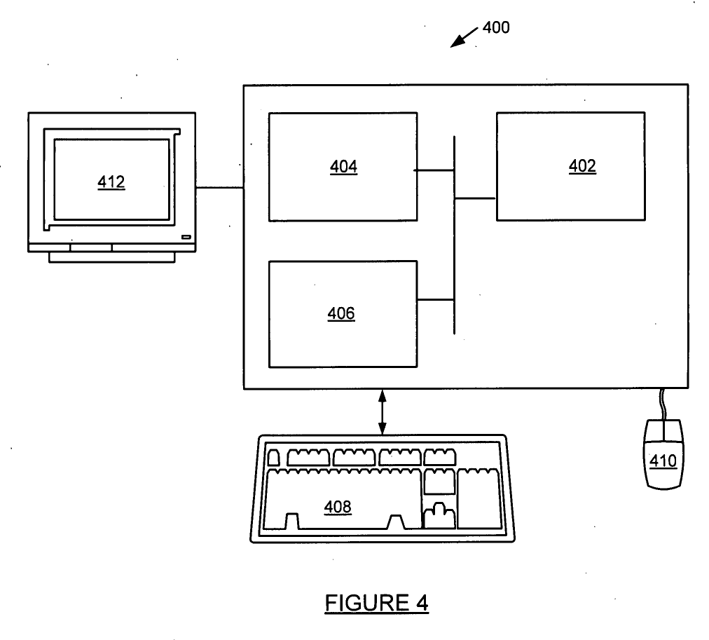

Embodiments of the invention may be implemented on virtually any type of computer regardless of the platform being used. For example, as shown in FIG. 4, a computer system (400) includes one or more processor(s) (402), associated memory (404) (e.g., random access memory (RAM), cache memory, flash memory, etc.), a storage device (406) (e.g., a hard disk, an optical drive such as a compact disk drive or digital video disk (DVD) drive, a flash memory stick, etc.), and numerous other elements and functionalities typical of today's computers (not shown). The computer (400) may also include input means, such as a keyboard (408), a mouse (410), or a microphone (not shown). Further, the computer (400) may include output means, such as a monitor (412) (e.g., a liquid crystal display (LCD), a plasma display, or cathode ray tube (CRT) monitor). The computer system (500) may be connected to a network (414) (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms. Generally speaking, the computer system (400) includes at least the minimal processing, input, and/or output means necessary to practice embodiments of the invention.

Further, those skilled in the art will appreciate that one or more elements of the aforementioned computer system (400) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computer readable storage medium comprising computer readable program code embodied therein for causing a computer system to:
receive, from a resource system, a re-directed access request for a resource associated with a second authentication level, wherein a user has requested access to the resource, wherein the user is associated with a session, and wherein the session associated with a first authentication level;
identify a second authentication context using the second authentication level;
generate an authentication request using the second authentication context;
send the authentication request to an identity provider, wherein the identity provider:
identifies an authentication scheme corresponding to the second authentication context,
obtains authentication information from the user,
authenticates the user using the authentication information, and
generates an assertion, in response to successful authentication, using the second authentication level, and the authentication scheme;
receive the assertion;
associate the session with the second authentication level to generate an upgraded session; and
allow the user access to the resource using the upgraded session.

2. The computer readable storage medium of claim 1, wherein the first authentication level is associated with a first authentication context.

3. The computer readable storage medium of claim 1, wherein the identity provider identifies the authentication scheme corresponding to the second authentication context using an authentication context-to-scheme map.

4. The computer readable storage medium of claim 1, wherein identifying the second authentication context further comprises using an authentication context-to-level map.

5. The computer readable storage medium of claim 1, wherein the assertion is defined using Security Assertion Markup Language (SAML) version 2.0.

6. The computer readable medium of claim 1, wherein the identity provider obtains authentication information from the user by prompting the user to enter the authentication information.

7. The computer readable storage medium of claim 1, wherein the resource comprises a software application.

8. A service provider, configured to:
receive, from a resource system, a re-directed access request for a resource associated with a second authentication level, wherein a user has requested access to the resource, wherein the user is associated with a session, and wherein the session associated with a first authentication level;
identify a second authentication context using the second authentication level;
generate an authentication request using the second authentication context;
send the authentication request to an identity provider, wherein the identity provider:
identifies an authentication scheme corresponding to the second authentication context,
obtains authentication information from the user,
authenticates the user using the authentication information, and
generates an assertion, in response to successful authentication, using the second authentication level, and the authentication scheme;
receive the assertion;
associate the session with the second authentication level to generate an upgraded session; and
allow the user access to the resource using the upgraded session.

9. The system of claim 8, wherein the first authentication level is associated with a first authentication context.

10. The system of claim 8, wherein the identity provider identifies the authentication scheme corresponding to the second authentication context using an authentication context-to-scheme map.

11. The system of claim 8, wherein identifying the second authentication context further comprises using an authentication context-to-level map.

12. The system of claim 8, wherein the assertion is defined using Security Assertion Markup Language (SAML) version 2.0.

13. The system of claim 8, wherein the resource comprises a software application.

14. A method for authentication, comprising:
receiving, from a resource system, a re-directed access request for a resource associated with a second authentication level, wherein a user has requested access to the resource, wherein the user is associated with a session, and wherein the session associated with a first authentication level;
identifying a second authentication context using the second authentication level;
generating an authentication request using the second authentication context;
sending the authentication request to an identity provider, wherein the identity provider:
identifies an authentication scheme corresponding to the second authentication context,
obtains authentication information from the user,
authenticates the user using the authentication information, and
generates an assertion, in response to successful authentication, using the second authentication level, and the authentication scheme;
receiving the assertion;
associating the session with the second authentication level to generate an upgraded session; and
allowing the user access to the resource using the upgraded session.

15. The method of claim 14, wherein the first authentication level is associated with a first authentication context.

16. The method of claim 14, wherein the identity provider identifies the authentication scheme corresponding to the second authentication context using an authentication context-to-scheme map.

17. The method of claim 14, wherein identifying the second authentication context further comprises using an authentication context-to-level map.

18. The method of claim 14, wherein the assertion is defined using Security Assertion Markup Language (SAML) version 2.0.

19. The method of claim 14, wherein the identity provider obtains authentication information from the user by prompting the user to enter the authentication information.

20. The method of claim 14, wherein the resource comprises a software application.
